(19) United States
(12) Patent Application Publication
(10) Pub. No.: US 2024/0190383 A1
(43) Pub. Date: Jun. 13, 2024

(54) System and Method for Releasing a Parking Brake of a Vehicle After Assessing Driver Alertness

(71) Applicant: Bendix Commercial Vehicle Systems LLC, Avon, OH (US)

(72) Inventors: Michael D. Cremona, Lakewood, OH (US); Thomas J. Hayes, Lakewood, OH (US); Andreas Kuehnle, Villa Park, CA (US)

(73) Assignee: Bendix Commercial Vehicle Systems LLC, Avon, OH (US)

(21) Appl. No.: 18/080,257

(22) Filed: Dec. 13, 2022

(51) Int. Cl. B60R 25/08; B60R 25/102; B60R 25/25; B60R 25/30; B60T 7/12; G06V 20/59; G06V 40/16

(52) U.S. Cl. CPC B60R 25/08; B60R 25/102; B60R 25/25; B60R 25/305; B60T 7/12; G06V 20/597; G06V 40/172; B60R 25/302; B60T 2220/02; B60T 2270/89

(57) ABSTRACT

A system and method for releasing a parking brake of a vehicle after assessing driver alertness is provided. In one embodiment, a controller in the vehicle determines whether the driver is alert (e.g., by providing a field sobriety test using component(s) in the vehicle) and allows the vehicle to unpark only if it determines that the driver is alert. The controller can also determine if the driver is an authorized driver and use that as an additional condition to release the parking brake.

### BACKGROUND

In some electronic parking systems in a vehicle (e.g., a truck towing a trailer), the parking brake cannot be released unless certain conditions are satisfied. For example, in some electronic parking systems, the parking brake cannot be released unless the vehicle driver is detected to be in the driver seat, the driver's seat belt is buckled, the driver's door is closed, the foot brake pedal is depressed, and/or the identity of the driver is verified (e.g., through facial recognition or a matching thumbprint or retina scan).

### BRIEF DESCRIPTION OF THE DRAWINGS

FIG. 1 is a diagram of a braking system of a vehicle of an embodiment.

FIG. 2 is a block diagram of a braking system of an embodiment.

FIG. 3 is a flow chart of a method of an embodiment for releasing a parking brake of a vehicle after authenticating a driver and assessing the driver's alertness.

### SUMMARY

In one embodiment, a non-transitory computer-readable storage medium storing a computer program having instructions that, when executed by one or more processors in a vehicle, cause the one or more processors to: determine whether a driver of the vehicle is an authorized user of the vehicle; determine whether the driver is alert; and allow the vehicle to unpark only if it is determined that the driver is the authorized user of the vehicle and that the driver is alert.

In another embodiment, a method is provided that is performed in a vehicle. The method comprises performing a field sobriety test on the driver of the vehicle using one or more components in the vehicle; and allowing a parking brake controller in the vehicle to unpark the vehicle only in response to the driver passing the field sobriety test.

In yet another embodiment, a system is provided comprising: a parking brake controller configured to unpark a vehicle; and means for allowing the parking brake controller to unpark the vehicle in response to determining that a driver of the vehicle is alert.

Other embodiments are possible, and each of the embodiments can be used alone or together in combination.

### DETAILED DESCRIPTION

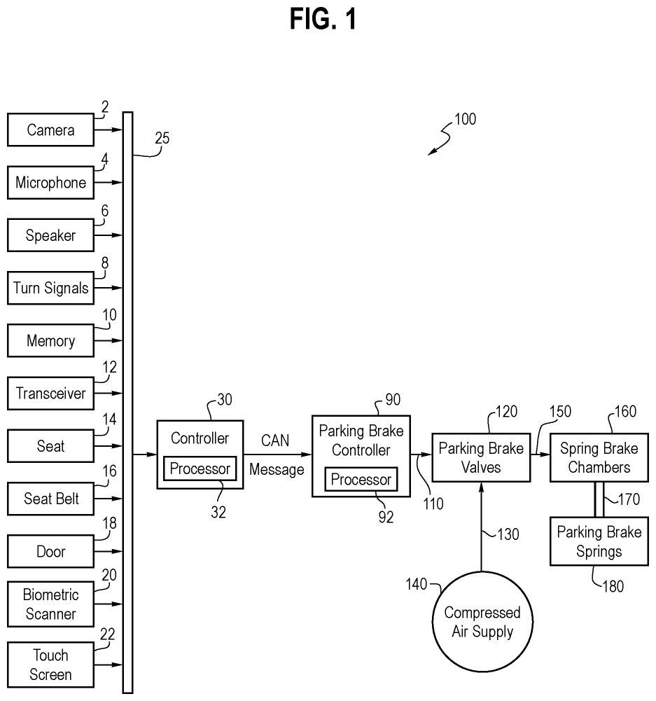

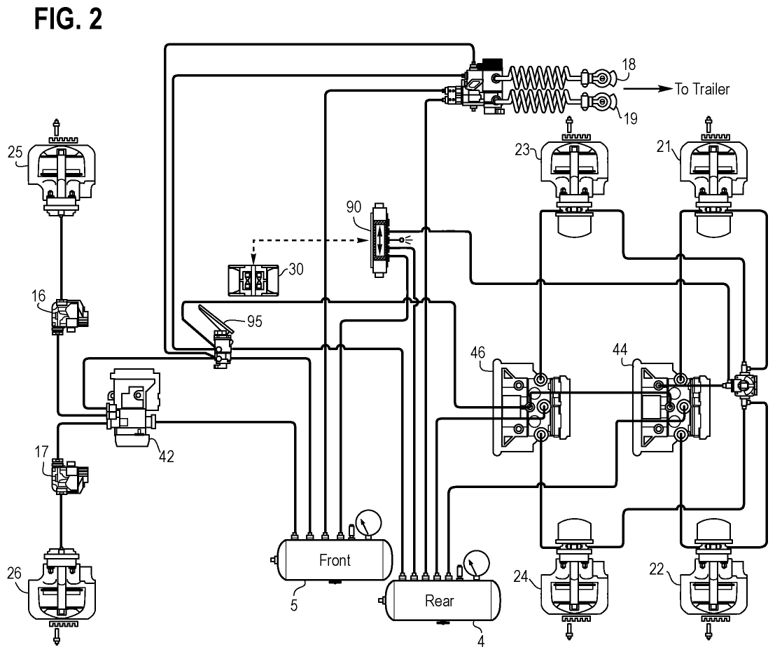

FIG. 1 is an illustration of a parking brake subsystem 100 of a vehicle of an embodiment. As shown in FIG. 1, in this embodiment, a controller 30 (sometimes referred to herein as an electronic controller unit (ECU) or safety controller) provides control signals to a parking brake controller 90 (e.g., over a controller area network (CAN) bus) to cause the parking brake controller 90 to release a parking brake of a vehicle upon driver demand. This parking brake sub-system can be used as part of any suitable type of vehicle braking system. FIG. 2 is an example of one such braking system, where the vehicle is a trailer capable of towing a trailer. It should be understood that this is merely an example and that other/different components can be used. In this example, the tractor has a rear drive axle, a front undriven (steer) axle (more than one steer axle can be used), and one or more optional axles. It is important to note that while a tractor is used in this example, these embodiments can also be applied to other vehicles, such as an automobile.

In operation, when the controller 30 receive the electronic brake request signals from a brake actuator 20 (e.g., a foot brake module), the controller 30 maps the signals representing the displacement to a requested deceleration and commands electro-pneumatic modules (EPMs) 42, 44, 46 on the undriven, optional, and driven axles to apply the appropriate amount of pressure needed to achieve that deceleration given various variables, such as, but not limited to, vehicle weight, weight distribution, whether a trailer is present, and driving conditions. In an electronic braking system (EBS), relays and modulators on an axle can be combined into an EPM, which is capable of electronically applying, holding, and releasing air to decelerate a wheel end of the axles. The EPMs 42, 44, 46 can cause the vehicle to decelerate in any suitable way. For example, in the embodiment shown in FIG. 2, the EPMs 44, 46 on the drive and optional axle are two-channel EPMs. EPM 44 communicates with friction brakes (here, air disc calipers 21, 22) on each braked wheel end of the steer axle, while EPM 46 communicates air disc calipers 23, 24 on each braked wheel end of the optional axle. The EPM 42 on the undriven axle in this example is a one-channel EPM that communicates, via modulators 16, 17, with air disc calipers 25, 26 on each braked wheel end of the undriven axle. Rear and front reservoirs 4, 5 can provide proportional pneumatic pressure to the EPMs 42, 44, 46. Pneumatic signals for braking can be applied to the trailer via the pneumatic control and supply lines 18, 19.

FIG. 2 also show the parking brake controller 90 in electronic communication with the controller 30 and in pneumatic communication with the rear and front reservoirs 4, 5, and the parking brakes of the rear axles of the vehicle. Referring back to FIG. 1, in this example, the controller 30 and the parking brake controller 90 each comprise respective processors 32, 92. The controller 30 and the parking brake controller 90 can comprises additional elements. Also, while shown as two separate controllers 30, 90 in FIG. 1, in other implementations, the two controllers are integrated into a single component, which may have two (or more) processors or a single processor. Accordingly, the phrase “at least one processor” is used herein to cover these and other variations and should not be read as requiring a specific implementation (e.g., a single controller or multiple controllers, two processors, etc.). The one or more processors can execute computer-readable program code having instructions (e.g., modules, routines, sub-routine, programs, applications, etc.) that, when executed by the one or more processors, cause the one or more processors to perform certain functions, such as some or all of those discussed herein. The computer-readable program code can be stored in a non-transitory computer-readable storage medium, such as, but not limited to, volatile or non-volatile memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof. The one or more processors can also take the form of a purely-hardware implementation (e.g., an application-specific integrated circuit (ASIC)).

Turning first to the parking brake controller 90, the parking brake controller 90 is part of a parking system comprising parking brake valves 120, a compressed air supply 140 (e.g., the rear and front reservoirs 4, 5 from FIG. 2), spring brake chambers 160, and parking brake springs 180. In this example, the parking brake springs 180 have a default state of applying pressure on braking components at the wheel end. When the parking brakes of the vehicle are applied, the parking brake controller 90 provides signals to the parking brake valves 120 so as to exhaust air in one or more chambers of spring brake chambers 180. When air in the spring brake chambers 180 is exhausted and system air pressure drops below a threshold (e.g., to less than about 45 psi to 60 psi), the parking brake springs 180 are activated to apply the vehicle parking brakes.

To release the parking brake, compressed air needs to flow from the compressed air supply 140 into the spring brake chambers 160 (via lines 130 and 150) to apply pneumatic pressure to the parking brake springs (via line 170) to release them from the braking position. The supply of compressed air from the compressed air supply 140 to the spring brake chambers 160 to release the parking brake is regulated by a parking brake valve 120, which is controlled by the processor 92 in the parking brake controller 90. In this example, the processor 92 in the parking brake controller 90 provides a signal (over channel 110) to open the parking brake valve in response to both driver demand to unpark the vehicle and a control signal from the processor 32 in the controller 30 indicating that it is ok for the parking brake controller 90 to satisfy the driver's demand. As noted above, the functionality of processors 32, 92 can be combined into one processor or distributed over more than two processors, which is why the phrase “at least one processor” is sometimes used herein.

To provide a driver demand/request to unpark the vehicle, the driver can interact with a user input device in the cabin of the vehicle (e.g., by pushing/pulling a button). However, as mentioned above, in this embodiment, that driver demand to unpark the vehicle will only be acted upon if the controller 30 allows it to. More specifically, the controller 30 can provide one or more safety checks and allow the driver's demand to be acted upon only if those safety check(s) are satisfied. With reference to FIG. 1, those safety check(s) can involve the use of the peripherals attached to a bus 25 connected to the controller 30. In this example implementation, these peripherals include, but are not limited to, a driver-facing camera 2, a microphone 4, a speaker 6, turn signals (or other visual indicators) 8, a memory 10, a transceiver 12, a seat sensor 14, a seat belt sensor 16, a door open/closed sensor 18, a biometric sensor (e.g., a retina or thumbprint scanner) 20, and a touch screen 22. It should be understood that the peripherals shown in FIG. 1 are merely examples, and fewer, different, or more peripherals can be used, such as, but not limited to, a stop lamp switch, a key ignition switch, a vehicle speed sensor, a brake pressure sensor, an engine revolutions-per-minute (RPM) sensor, a throttle position sensor, a steering angle sensor, a clutch position sensor, and other controllers. Also, it should be noted that the peripherals (and other components discussed herein that may be in electrical communication) can be in wired or wireless communication.

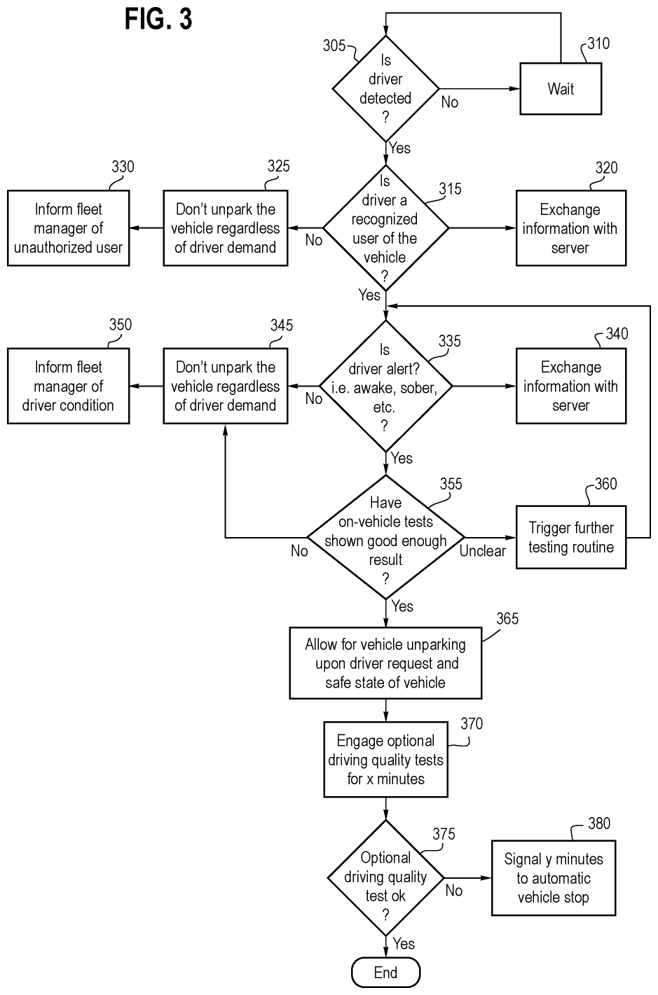

In this embodiment, one or both of the following checks can be made: (1) a determination of whether the driver is authorized to use the vehicle and (2) a determination of whether the driver is alert enough to operate the vehicle. Of course, this is only an example, and fewer/more/different checks can be made. This example will now be described with reference to the flow chart in FIG. 3. While FIG. 3 shows both checks being made, it should be understood that only one check may be performed (e.g., the alertness test but not driver authentication, or vice versa).

As shown in FIG. 3, the processor 32 in the controller 30 first determines if a driver is detected (act 305). This detection can be done in any suitable way (e.g., when the driver-facing camera 2 detects an image of a person or when a signal is received from the seat sensor 14 indicating that a person is seated in the driver seat). If a driver is not detected, the processor 32 waits (act 310), possibly performing other operations. When a driver is detected, the processor 32 determines if the driver is a recognized user of the vehicle (act 315). This can be useful, for example, to prevent someone from stealing the vehicle when the driver exits the vehicle without locking the door or when the driver is forcibly removed from the vehicle by an assailant.

To determine whether the driver is a recognized user of the vehicle, the processor 32 can communicate information with an external server via the transceiver 12 (act 320). For example, the processor 32 can send, to the server, an image of the driver captured by the camera 2, and the server can compare the image to a library of stored images of recognized users of the vehicle and return a response to the processor 32 indicating whether or not the driver is a recognized user (e.g., whether there is a match to the images in the library). Alternatively, the processor 32 can be provided with the relevant information (e.g., from the server or another entity at or before the time the information in needed) to be stored in a local database in the vehicle for the processor 32 to do the image comparison. As another alternative, instead of or in addition to using an image of the driver captured by the driver-facing camera 2, other information about the driver can be used to determine whether the driver is a recognized user of the vehicle. Such other information can include, but is not limited to, a thumbprint or retina scan of the driver, a bar code on a driver's ID card, a password, etc.).

If the driver is not a recognized user of the vehicle, the processor 32 does not allow the vehicle to unpark regardless of driver demand (act 325) (e.g., the processor 32 does not send a release signal to the parking brake controller 90 or affirmatively sends a signal to the parking brake controller 90 not to release the parking brake). The processor 32 can also inform a fleet manager or other entity (in real time or later) of the unauthorized user (act 330). However, if the driver is a recognized user of the vehicle, the processor 32 then proceeds with the next step of determining whether the driver is alert (e.g., awake, sober, etc.) (act 335). To make this determination on whether it is safe for the driver to drive the vehicle, the processor 32 can provide one or more alertness tests to the driver, which may or may not involve exchanging information with the server (act 340). The results of these test(s) can be compared to a threshold to determine whether or not the driver is considered “alert” (e.g., if the results are above the threshold, the driver is considered alert; otherwise, the drive is not considered alert). Multiple thresholds can be used to determine degrees of alertness (e.g., if the results are below a first threshold, the driver is considered not be alert; if the results are above a second threshold, the driver is considered to be alert; but if the results are between the first and second thresholds, the driver may have some alertness impediment, where the driver may or may not be considered “alert enough’ to drive. Of course, this is just one example, and other implementations (e.g., using more threshold level, not using threshold levels, using artificial intelligence to analyze the results, etc.) can be used.

If the driver is not determined to be alert, the processor 32 does not allow the vehicle to unpark regardless of driver demand (act 345) (e.g., the processor 32 does not send a release signal to the parking brake controller 90 or affirmatively sends a signal to the parking brake controller 90 not to release the parking brake). The processor 32 can also inform a fleet manager or other entity (in real time or later) of the driver's condition (act 350). Conversely, if the driver is determined to be alert, the processor 32 can allow the vehicle to unpark in response to driver demand (act 365). Optionally, the processor 32 can provide additional testing. For example, as shown in FIG. 3, even if the driver's alertness level is above a baseline threshold level, the processor 32 can determine whether that level is “good enough” (e.g., is above the baseline threshold level by a certain amount) (act 355). If the results of the initial testing are unclear (e.g., they are above the first threshold but below the second threshold mentioned above), further testing can be done prior to allowing the vehicle to be unparked (act 360). However, if the results are below the first threshold, the vehicle can be kept unparked despite driver demand (act 345). If the results are above the second threshold, the vehicle can be unparked (act 365).

Any suitable type of testing can be used to determine an alertness level of a driver, such as a brake interlock field sobriety test. In one embodiment, the processor 32 performs a version of the National Highway Traffic Safety Administration's (NHTSA's) field sobriety test for a seated driver using one or more components in the vehicle. To conduct the test, the processor 32 can cause pre-recorded audio tracks (e.g., instructions) to be played from the speakers 4 and/or cause visual instructions to be displayed on the touch screen display device 22. For example, to emulate a horizontal Nystagmus test, where an object is tracked with the eyes, the processor 32 can cause indicator lights or blinkers in on the dashboard to illuminate, and the characteristic “dancing” movement of the driver's eyes can be tracked by the driver-facing camera 2. If the processor 32 determines that the driver's eye movements exceed a frequency or amplitude threshold, the processor 32 can consider that an indication that the driver's ability to drive the vehicle is impaired.

As another example, the processor 32 can output instructions via the speakers 8 and/or touch screen 22 to test the driver's reaction, thinking, and coordination skills (e.g., as an initial filter for further possible fleet or server examination, camera and other information from the vehicle can be send to the server for analysis). Such instructions can include, but are not limited to, instructing the driver to touch a particular finger to his nose, touch particular fingers of both hands to his nose at the same time (e.g., either both thumbs to the nose or the hands in a chain after each other (“cocking a snook”)). The processor 32 can also recognize “landmarks” on the driver's face (e.g. mouth, nose tip, etc.), as well as a location of the driver's hands, and the processor 32 can analyze images of the driver taken by the camera 2 to determine (locally or through the use of the external server) to determine whether the driver satisfactorily passed the test. The images from the camera 2 can also be used to analyze the driver's head pose (e.g., yaw, roll, pitch) and whether the driver's eyes are open or closed, which can be an indication of alertness.

Of course, many other tests are possible. For example, the processor 32 can instruct the driver to press a certain button on the dashboard (e.g., on the fifth blinking of the right-side indicator, where the left blinker is interspersed into the right-side blinking, which is akin to testing the ability to follow instructions used in the (validated) walk (in a straight line) and turn test). As another example, to test reaction time, the processor 32 can instruct the driver to press a certain button on the dash as soon as it starts blinking, with or without advanced warning as to which side of the dash the test will take place. Other tests that give a stimulus and monitor the response time (e.g., the elapsed time between stimulus and response) can be used. Further, other components in the vehicle can be used to perform the test, such as, but not limited to, the vehicle's turn signals 8, speakers 8, biometric scanner 20 (e.g. a breath analyzer), touch screen 22, and microphone 4 (e.g., to record and analyze the driver's voice to detect slurring; repeating of particularly difficult to pronounce phrases may be requested, for example).

Because field sobriety tests are not necessarily pass/fail tests but rather an indication regarding a person's state, further testing/monitoring of the driver may be desired after “passing” the test after a preliminary brake release is allowed (e.g., if the results are between the first and second thresholds mentioned above). For example, as shown in FIG. 3, the processor 32 can provide optional driving tests for a certain period of time after the vehicle is unparked (act 370) and assess the driving quality as a measure of driver alertness (act 375). If that testing indicates the driver may not be alert, the processor 32 can provide an indication (e.g., audio or video) to the driver that the vehicle will automatically stop or park in a certain amount of time or within a certain distance (act 380).

Any suitable type of testing can be used to provide further in-vehicle driving quality tests, such as, but not limited to, the type of testing discussed above. Additionally or alternatively, the processor 32 can monitor a standard deviation of lane position (SDLP)) (e.g., using a forward-facing camera to detect lane swerving), monitor how closely the driver is driving to a forward vehicle (e.g., by calculating the percentage of time spent at <X seconds to the forward vehicle ahead), or monitor any other input to look for abnormal deviations from acceptable performance (e.g., as specified in fleet or individual driver standards). Of course, these are merely examples, and other types of testing can be used.

There are many alternatives that can be used. For example, if the vehicle is in an emergency situation and the driver is unable to move the vehicle (e.g., if a tow truck driver needs to unpark the truck), the above checks can be bypassed from a possible message originating from a fleet manager or another authority source.

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein. Additionally, “in response to” can be directly in response to or indirectly in response to.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A non-transitory computer-readable storage medium storing a computer program having instructions that, when executed by one or more processors in a vehicle, cause the one or more processors to:
determine whether a driver of the vehicle is an authorized user of the vehicle;
determine whether the driver is alert; and
allow the vehicle to unpark only if it is determined that the driver is the authorized user of the vehicle and that the driver is alert.

2. The non-transitory computer-readable storage medium of claim 1, wherein determining whether the driver of the vehicle is the authorized user of the vehicle comprises comparing an image of the driver taken by a camera in the vehicle to a plurality of images of authorized users of the vehicle.

3. The non-transitory computer-readable storage medium of claim 2, wherein the comparing is performed by the one or more processors in the vehicle.

4. The non-transitory computer-readable storage medium of claim 2, wherein the instructions, when executed by the one or more processors, further cause the one or more processors to:
send the image of the driver to one or more processors external to the vehicle to do the comparing.

5. The non-transitory computer-readable storage medium of claim 1, wherein the instructions, when executed by the one or more processors, further cause the one or more processors to:
in response to determining that the driver of the vehicle is not the authorized user of the vehicle, send a notification to an external entity.

6. The non-transitory computer-readable storage medium of claim 1, wherein the instructions, when executed by the one or more processors, further cause the one or more processors to:
in response to determining that the driver of the vehicle is not alert, send a notification to an external entity.

7. The non-transitory computer-readable storage medium of claim 1, wherein determining whether the driver of the vehicle is alert comprises using one or more components of the vehicle to perform a field sobriety test.

8. The non-transitory computer-readable storage medium of claim 7, wherein the one or more components comprise at least one of the following: a camera, a microphone, a speaker, an indicator light, a biometric sensor, and a display device.

9. The non-transitory computer-readable storage medium of claim 1, wherein the instructions, when executed by the one or more processors, further cause the one or more processors to:
repeat an alertness test.

10. The non-transitory computer-readable storage medium of claim 1, wherein the instructions, when executed by the one or more processors, further cause the one or more processors to:
after allowing the vehicle to unpark, monitor a quality of driving of the driver.

11. The non-transitory computer-readable storage medium of claim 10, wherein the instructions, when executed by the one or more processors, further cause the one or more processors to:
in response to the quality of driving not being satisfactory, cause the vehicle to automatically stop.

12. A method comprising:
performing in a vehicle:
performing a field sobriety test on the driver of the vehicle using one or more components in the vehicle; and
allowing a parking brake controller in the vehicle to unpark the vehicle only in response to the driver passing the field sobriety test.

13. The method of claim 12, wherein the one or more components comprise at least one of the following: a camera, a microphone, a speaker, an indicator light, a biometric sensor, and a display device.

14. The method of claim 12, further comprising:
assessing a quality of driving after allowing the parking brake controller to unpark the vehicle; and
causing the vehicle to stop in response to the quality of driving being below a standard.

15. The method of claim 12, further comprising:
receiving an image of a driver from a driver-facing camera of the vehicle; and
determining whether the image of the driver matches an image in a library of images of authorized users of the vehicle;
wherein the parking brake controller is allowed to unpark the vehicle only in response to both the driver passing the field sobriety test and determining that the image of the driver matches the image in the library of images.

16. The method of claim 15, wherein the library of images is locally stored in the vehicle and one or more processors in the vehicle determine whether the image of the driver matches the image in the library of images.

17. The method of claim 15, further comprising:
sending the image of the driver to an external server that is configured to match the image of the driver to the image in the library of images;
wherein determining whether the image of the driver matches the image in the library of images comprising receiving an indication from the external server regarding a successful match.

18. A system comprising:
a parking brake controller configured to unpark a vehicle; and
means for allowing the parking brake controller to unpark the vehicle in response to determining that a driver of the vehicle is alert.

19. The system of claim 18, wherein the driver is determined to be alert in response to the driver passing a field sobriety test performed using one or more components in the vehicle.

20. The system of claim 18, further comprising means for determining whether the driver is an authorized driver using an image of the driver taken by a camera in the vehicle.
